(19) United States
(12) Patent Application Publication
(10) Pub. No.: US 2006/0172099 A1
(43) Pub. Date: Aug. 3, 2006

(54) Metal plate coated with polyester resin, and can using the same

(75) Inventors: Lianchun Hu, Kudamatsu-shi (JP); Narimasa Maida, Kudamatsu-shi (JP); Satoshi Takahashi, Kudamatsu-shi (JP); Hiroshi Kurisu, Kudamatsu-shi (JP)

Correspondence Address: BROWDY AND NEIMARK, P.L.L.C.;624 NINTH STREET, NW, SUITE 300, WASHINGTON, DC, 20001-5303, US

(73) Assignee: Toyo Kohan Co. Ltd., Tokyo (JP)

(21) Appl. No.: 11/113,312

(22) Filed: Apr. 25, 2005

(30) Foreign Application Priority Data
Feb. 2, 2005 (EP) 05002159.1

(51) Int. Cl. B32B 15/08; B32B 15/09; B32B 27/36

(52) U.S. Cl. 428/35.8; 428/458; 428/141; 428/480

(57) ABSTRACT

The present invention intends to provide a metal plate coated with polyester resin which does not generate cracks and fractures and is excellent in moldability and corrosion resistance when being applied by a severe molding processing, and to provide a can using the same which is excellent in preservation of flavoring properties for content. For this purpose, the metal plate, which the surface roughness Ra (JIS B 0601) is 1 μm or less, coated with polyester resin of the present invention is coated on at least one side thereof with a monolayer polyester resin or a two-layer polyester resin; the monolayer polyester resin or the two-layer polyester resin which has an intrinsic viscosity of 0.6 to 1.4

### DETAILED DESCRIPTION OF THE INVENTION

1. Technical Field

The present invention relates to a metal plate coated with polyester resin and a can using the same. In more detail, the invention relates to a metal plate coated with polyester resin which is excellent to moldability, corrosion resistance and preservation of flavoring properties of content (flavor sustainability), especially applicable to beverage cans, and a can using the same by applying deep drawing processing or the like.

2. Background Art

In these days, cans are used, especially for beverage can usage, which are manufactured with a metal plate coated with a biaxially-stretched oriented polyester resin film by employing severe molding processing such as wall-thinning deep drawing processing with high contraction ratio and high reducing ratio in the thickness of side wall of the can, and the like processing. When this metal plate coated with a biaxial-stretched oriented polyester resin film is molded by the wall-thinning deep drawing processing, because the resin film coated on the surface of a metal plate can not enough subject to the large deformation in processing, fine cracks generated in the film result in deterioration of corrosion resistance, and the can shell is broken by the film fracture caused in can molding, and further processing becomes impossible; therefore, further cost reduction by enhancing contraction ratio and thickness reducing ratio is extremely difficult. Although the moldability is improved by reducing biaxial orientation of the polyester film or making it non-oriented, resin cystallinity is reduced, resulting in decrease of permeability resistance of the resin film against water or oxygen and deterioration of corrosion resistance and preservation of flavoring properties of content when the can containing contents is retained for long time.

The present invention intends to provide a metal plate coated with polyester resin which is free from crack generation or fracture under severe molding processing such as wall-thinning deep drawing and is excellent to moldability and corrosion resistance, and a can using the same which is superior with respect to preservation of flavoring properties of the content.

### DISCLOSURE OF THE INVENTION

A metal plate, wherein the surface roughness Ra (JIS B 0601) is 1 μm or less, coated with polyester resin according to claim 1 is characterized by being coated on at least one side of the metal plate with a polyester resin having an intrinsic viscosity of 0.6 to 1.4.

In the coated metal plate, the polyester resin has preferably 50 seconds or more of a half crystallization time measured by a differential scanning calorimetry.

A metal plate coated with polyester resin according to claim 3 is characterized by including a two-layer coating coated on at least one side of the metal plate, wherein the two-layer coating includes an upper layer of a polyester resin according to claim 1 having less than 80 seconds of the half crystallization time and a lower layer of a polyester resin according to claim 1 having 50 seconds or more of the half crystallization time.

In this coated metal plate, the half crystallization time of the upper layer is preferably shorter than that of the lower layer.

In this coated metal plate, the polyester resin is preferably non-oriented.

In this coated metal plate, the metal plate is preferably any of a tinned steel plate, a tin-free steel plate or an aluminum alloy plate.

A can according to claim 7 is characterized by the can using metal plate coated with polyester resin according to any of claims 1 to 6.

### BEST MODE FOR CARRYING OUT THE INVENTION

The present invention is a metal plate coated with polyester resin in which a mono-layer polyester resin is coated on at least one side of the metal plate wherein the resin has an intrinsic viscosity of 0.6 to 1.4 and a half crystallization time of 50 seconds or more, or a two-layer polyester resin is coated on at least one side of the metal plate, the two-layer which includes an upper layer of a resin having half crystallization time of less than 80 seconds and a lower layer of a resin having half crystallization time of 50 seconds or more, wherein the intrinsic viscosities of resins of both layers are ranging from 0.6 to 1.4; this metal plate does not cause crack generation or fracture in the resin under severe molding processing such as wall-thinning deep drawing, and exhibits excellence in moldability and corrosion resistance. A can using the metal plate coated with polyester resin of the invention is superior with respect to preservation of flavoring properties of the content.

The present invention is described in detail as follows.

The polyester resin applied to the present invention is described. The polyester resin is preferably a polyester resin having an ester unit such as an ethylene terephthalate, an ethylene isophthalate, a butylene terephthalate, a butylene isophthalate and the like, more preferably a polyester having mainly at least one kind of ester unit selected from the group thereof. In the polyester resin, each ester unit may be copolymerized, further be blended with homopolymer or copolymer including two or more kinds of ester units. A polyester resin, other than those described above, may be used; the polyester resin which uses a naphthalene dicarboxylic acid, an adipic acid, a sebacic acid, a trimellitic acid and the like as an acid component of the ester unit thereof; or which uses a propylene glycol, a diethylene glycol, a neopentyl glycol, a cyclohexanedimethanol, a pentaethythritol and the like as an alcohol component of the ester unit thereof.

Since the present invention, as mentioned hereinafter, is subjected to use a non-oriented polyester resin, the resin must be reinforced by increasing the intrinsic viscosity in order to avoid disadvantages such as the resin being cut during the work coating the polyester resin on a metal plate, and the resin being ground or scarred as well as being cracked, broken, furthermore peeled off when being applied with severe molding processing such as wall-thinning deep drawing to the metal plate coated with the polyester resin. For this purpose, the intrinsic viscosity of the polyester resin is preferably in the range of from 0.6 to 1.4, more preferably from 0.8 to 1.2. When a polyester resin having an intrinsic viscosity of less than 0.6 is used, the strength of the resin is extremely decreased and such resin can not be employed to a wall-thinning deep drawing can intended by the present invention. On the other hand, when the intrinsic viscosity exceeds 1.4, the melt viscosity of the resin molten by heat is significantly increased, resulting in that the work to coat the polyester resin on a metal plate becomes extremely difficult.

Moreover, when the polyester resin is coated on a metal plate as a monolayer, the half crystallization time of the polyester resin measured by a differential scanning calorimetry (DSC) is preferably 50 seconds or more. The term of half crystallization time used in the present invention is defined as follows. That is, a pre-determined weight of polyester resin peeled off from a metal plate coated with polyester resin is heated with a differential scanning calorimetry (DSC) under temperature raising rate of 90° C./minute to 290° C., which temperature is above the melting temperature of a polyester resin, to be melted and then held for 3 minutes, followed by quenching under cooling rate of 200° C./minute to 30° C. to make the resin amorphous. Thus obtained amorphous resin is again heated with the DSC under temperature raising rate of 90° C./minute to 160° C. where the resin is crystallized, and held for 20 minutes to complete crystallization. When the absorbed heat value of the resin thus treated is consecutively measured at 160° C. from the commencement of the holding, a bottom part appears in the heat absorption peak curve after a certain time elapsed. In the present invention, the time from the commencement of the holding at 160° C. to appearance of bottom part of the heat absorption peak is defined as the half crystallization time.

It means that: the shorter the half crystallization time is, the higher the crystallinity of resin is; the longer the half crystallization time is, the lower the crystallinity of resin is.

When the polyester resin is coated as monolayer on a metal plate, if high crystallinity polyester resin having the half crystallization time of less than 50 seconds is employed, adhesive ability of the resin to a metal plate is poor; consequently, when a severe molding such as wall-thinning deep drawing is applied, the resin is easily pealed off from a metal plate, and fractures and cracks tend to generate in the resin layer; this is not preferable.

In the present invention, a resin including two layers of the above described polyester resin may be coated on a metal plate; that is, being coated with a two-layer polyester resin including an upper layer of polyester resin having the half crystallization time of less than 80 seconds and a lower layer of polyester resin having the half crystallization time of 50 seconds or more. When employing such two-layer polyester resin, the lower layer polyester resin is preferably a low crystallinity polyester resin having the half crystallization time of 50 seconds or more in order to secure adhesion ability with a metal plate, especially adhesion ability in processing operation. On the other hand, the upper layer polyester resin is preferably a high crystallinity polyester resin having the half crystallization time of less than 80 seconds in order to improve permeability resistance against content to secure corrosion resistance along with securing well preservation of flavoring properties; moreover, the half crystallization time of the upper layer is preferably shorter than that of the lower layer in order to use this two-layer polyester resin more effectively.

The polyester resin described above of the present invention is used, in any cases, in non-oriented state which is superior with respect to molding processing ability, in order to be subjected to a severe molding such as wall-thinning deep drawing without generation of cracks, fractures or peeling in the resin.

A thickness of polyester resin described above coated on a metal plate is, when being coated in the monolayer, preferably 5 to 60 μm, more preferably 10 to 40 μm. If the thickness is less than 5 μm, the work coating the resin on a metal plate becomes significantly difficult, and the resin layer applied by the wall-thinning deep drawing tends to cause defects and is not sufficient in its permeability resistance. On the other hand, although increasing thickness is advantageous for permeability resistance, the thickness of 60 μm or more is economically disadvantage. When being coated with the two-layer of the upper layer and the lower layer, the thickness of upper resin layer is preferably 2 to 57 μm and that of lower resin layer is preferably 3 to 58 μm. If the thickness of upper resin layer is extremely thin, the permeability resistance and preservation of flavoring properties may become not sufficient depending on the kind of content contained; on the other hand, if the thickness of lower resin layer is extremely thin, the adhesion ability in processing becomes not sufficient.

In the above described resin, as long as not impairing the properties thereof, stabilizers, antioxidation agents and lubricant such as silica may be added.

The metal plate as a substrate of the metal plate coated with polyester resin of the present invention may employ various surface treated steel sheets such as a tinned steel plate usually widely used as a material for can and a electrolytic chromium coated steel (tin-free steel plate, referred to as TFS hereinafter) and the like, and an aluminum alloy plate. The surface roughness Ra (JIS B 0601) of the metal plate is preferably 1.0 μm or less, more preferably 0.5 μm or less. If the surface roughness Ra is exceeding 1.0 μm, a lot of bubbles exist between the polyester resin and the meatl plate after laminating with the polyester resin. The polyester resin is cut down or the can body is broken when being applied by a severe molding processing such as wall-thinning deep drawing. As surface treated steel sheets, preferable is a tin-free steel plate in which two layer coating is formed on the surface of a steel, the two layer coating which includes a lower layer having metal chromium coating value of 10 to 200 mg/m² and a upper layer having hydrous chromium oxide coating value of 1 to 30 mg/m² in terms of chromium; and this plate has sufficient adhesion ability with the polyester resin of the present invention along with corrosion resistance. As the tinned steel plate, preferable is a sheet in which tin is plated on a steel sheet in the plated amount of 0.1 to 11.2 mg/m² and has a two- or mono-layer coating formed on the tin plating; the two-layer coating which includes metal chromium and hydrous chromium oxide in the coating value of 1 to 30 mg/m² in terms of chromium; the monolayer coating which consists only of hydrous chromium oxide. In any cases, the steel sheet to be the substrate is preferably a low carbon cold rolled steel sheet which is generally used for the material for cans. The thickness of the steel sheet is preferably 0.1 to 0.32 mm. Regarding to an aluminum alloy plate, those defined in JIS-3000 or -5000 series are preferable; more preferable is the one on which surface two layer coating is formed by electrolytic chromium acid treatment, the two layer which comprises a lower layer having metal chromium coating value of 0 to 200 mg/m² and a upper layer having hydrous chromium oxide coating value of 1 to 30 mg/m² in terms of chromium; or the another on which surface chromium and phosphorous components are adhered by phosphoric acid chromate coating treatment in the amount of 1 to 30 mg/m² in terms of chromium and the amount of 0 to 30 mg/m² in terms of phosphorous. The thickness of the aluminum alloy plate is preferably 0.15 to 0.4 mm.

The method to coat the polyester resin of the present invention on the metal plate can apply any of known film laminating methods or extrusion laminating methods.

When coating by the film laminating methods, resin pellets are heated to melt at a temperature of 20 to 40° C. higher than the melting temperature thereof, cast from a T-die on a cooled casting roll, and then rewound by a coiler without elongating to produce non-oriented resin film. On the other hand, the metal plate wound as a long sheet is unwound from an uncioler along with the unwound sheet being heated to a temperature of 20 to 40° C. higher than the melting temperature of the resin, the heated metal plate being subjected to contact with the non-oriented resin film which being unwound, and then both of them being pressed by a pair of lamination rolls to adhere each other, followed by immediately quenching in water to prevent the resin from crystallization.

When coating by the extrusion laminating methods, resin pellets are heated to melt at a temperature of 20 to 40° C. higher than the melting temperature thereof, cast from a T-die directly on the long-sheet metal plate which is unwound from an uncioler, followed by immediately quenching in water to prevent the resin from crystallization.

Adhesives may be interposed between the polyester resin and the metal plate for laminating. This lamination method is applied for a tinned steel plate or the like in which the temperature of metal plate can not be raised so high because the plating layer of the metal plate melts in the film laminating methods. The kinds of adhesives used for the present invention is not particularly limited, preferably used are epoxy/phenol adhesives, epoxy/urea adhesives, urethane adhesives and the like.

Furthermore, the metal plate coated with polyester resin of the present invention is coated with the polyester resin of the invention on the one side of the metal plate, but the other side thereof may be not coated, or be coated simultaneously or in each side with a resin other than the resin of the present invention, for example, such as a biaxially oriented polyester resin film, a non-oriented polyester resin other than the resin of the invention, a polyamide and a polyolefin other than a polyester, or the colored resins thereof. Moreover, the metal plate may be painted by various resin paints.

### EXAMPLE

The present invention is explained in detail according to the Examples.

The polyester resin exhibited in Table 1 coated on the one side of the metal plate having the surface roughness Ra as shown in Table 1 and the polyester copolymer resin (melting temperature: 229° C., referred to as a white resin hereinafter) coated on the other side of the metal plate which includes ethylene terephthalate 88% by mole/ethylene isophthalate 12% by mole and contains 20% by weight of titanium dioxide, were heated to melt and mix by a biaxial extruder at the temperature of around 30° C. higher than the melting temperatures (Tm) of respective resins, sent to a T-die having nozzle width of 1000 mm (in case of the two-layer resin, a T-die capable co-extrusion) to extrude out from the die nozzles and then trimmed as a film of 800 mm width to be wound as the non-oriented film. PET in Table 1 is the polyethylene terephthalate and PETI is the polyester copolymer resin of ethylene terephthalate and ethylene isophthalate. The value described followed by the resin composition in Table 1 represents the mole % of isophthalic acid. Sample number 8 represents that the resin is a blended resin with the resin composition of PETI—10% by mole (67% by weight) and PETI—25% by mole (33% by weight). Sample number 17 represents that the lower layer is the blended resin with the resin composition of PETI—10% by mole (67% by weight) and PETI—25% by mole (33% by weight).

As the metal plate, 3 kinds of long-sheet metal plates applied by surface treatment described below were prepared.

1) TFS

Plate Thickness: 0.18 mm

Plate Width: 800 mm

Metal Chromium Amount: 150 mg/m²

Hydrous Chromium Oxide Amount: (in term of chromium) 18 mg/m²

2) Tinned Steel Plate

Plate Thickness: 0.18 mm

Plate Width: 800 mm

Tin Plating Amount: 0.2 mg/m²

Hydrous Chromium Oxide Amount: (in term of chromium) 7 mg/m²

3) Aluminum Alloy Plate (JIS 5052H39)

Thickness: 0.26 mm

Plate Width: 800 mm

Coating Amount: (in terms of phosphorous) 9 mg/m² (in terms of chromium) 8 mg/m²

For any of metal plates described above, the one side thereof was laminated with non-oriented film of any of polyester resins listed in Table 1 and the other side was laminated with the non-oriented film of the white resin by means of a pair of lamination rolls after heating the metal plate. The temperature of the metal plate just before contacting a pair of lamination rolls was set in around 30° C. higher than the Tm of the polyester in the case of TFS or the aluminum alloy plate, or set at 200° C. in the case of tinned steel plate. To laminate on the tinned steel plate, the polyester resin and the non-oriented white film were respectively coated with a epoxy/phenol adhesive in 1.0 μm thickness on the one side of each resin and then heated to solidify before lamination, followed by lamination by subjecting the coated face to contact with tinned steel plate face. Lamination was carried out in the laminating rate of 150 m/minute, followed by immediate quenching in water to prevent crystallization and then drying.

Thus, the metal plate coated with polyester resin laminated with the polyester resin on the one side thereof and with the white resin on the other side thereof was produced.

TABLE 1
Specification of metal palte and polyester resin

| | | | Polyester Resin | | | | | | | | |
|---|---|---|---|---|---|---|---|---|---|---|---|
| | | | | | | | Lower Layer | | | | |
| | Metal Plate | | Upper Layer | | | | Resin | | Half | | |
| | | Surface | Resin | | Half Crys- | | Composition | | Crystall- | | |
| | | rough- | Composition | | tallization | Thick- | (mole % of | | ization | Thick- | |
| Sample | Surface | ness | (mole % of | Intrinsic | Time | ness | isophthalic | Intrinsic | Time | ness | |
| No | treatment | (Ra) | acid) | Viscosity | (sec.) | (μm) | acid) | Viscosity | (sec.) | (μm) | Classification |
| 1 | TFS | 0.2 | PET | 0.85 | 13 | 30 | — | — | — | — | Comparative |
| | | | | | | | | | | | Example |
| 2 | TFS | 0.2 | PETI-5 | 0.85 | 21 | 30 | — | — | — | — | Comparative |
| | | | | | | | | | | | Example |
| 3 | TFS | 0.2 | PETI-12 | 0.8 | 58 | 30 | — | — | — | — | Present |
| | | | | | | | | | | | Invention |
| 4 | TFS | 0.2 | PETI-10 | 1.0 | 63 | 28 | — | — | — | — | Present |
| | | | | | | | | | | | Invention |
| 5 | TFS | 0.2 | PETI-15 | 0.9 | 136 | 20 | — | — | — | — | Present |
| | | | | | | | | | | | Invention |
| 6 | TFS | 0.2 | PETI-20 | 0.9 | 174 | 10 | — | — | — | — | Present |
| | | | | | | | | | | | Invention |
| 7 | TFS | 0.2 | PETI-25 | 1.0 | Amorphous | 20 | — | — | — | — | Present |
| | | | | | | | | | | | Invention |
| 8 | Aluminum | 0.3 | PETI-10 | 0.85 | 70 | 32 | — | — | — | — | Present |
| | Alloy | | (67 wt %) | | (after | | | | | | Invention |
| | Sheet | | PETI-25 | 1.0 | blended) | | | | | | |
| | | | (33 wt %) | | | | | | | | |
| 9 | Tin Plate | 0.3 | PETI-12 | 0.5 | 35 | 25 | — | — | — | — | Comparative |
| | | | | | | | | | | | Example |
| 10 | Tin Plate | 0.3 | PETI-12 | 0.6 | 45 | 25 | — | — | — | — | Comparative |
| | | | | | | | | | | | Example |
| 11 | Tin Plate | 0.3 | PETI-12 | 0.8 | 58 | 25 | — | — | — | — | Present |
| | | | | | | | | | | | Invention |
| 12 | Tin Plate | 0.3 | PETI-12 | 1.2 | 82 | 25 | — | — | — | — | Present |
| | | | | | | | | | | | Invention |
| 13 | Tin Plate | 0.3 | PETI-12 | 1.4 | 105 | 25 | — | — | — | — | Present |
| | | | | | | | | | | | Invention |
| 14 | TFS | 0.2 | PETI-5 | 1.0 | 27 | 6 | PETI-12 | 0.7 | 44 | 25 | Comparative |
| | | | | | | | | | | | Example |
| 15 | TFS | 0.2 | PETI-5 | 1.0 | 27 | 6 | PETI-10 | 0.85 | 53 | 25 | Present |
| | | | | | | | | | | | Invention |
| 16 | TFS | 0.2 | PETI-10 | 0.85 | 53 | 6 | PETI-15 | 0.9 | 138 | 25 | Present |
| | | | | | | | | | | | Invention |
| 17 | TFS | 0.2 | PETI-10 | 1.0 | 63 | 6 | PETI-10 | 0.85 | 70 (after | 25 | Present |
| | | | | | | | (67 W %) | | blended) | | Invention |
| | | | | | | | PETI-25 | 1.0 | | | |
| | | | | | | | (33 W %) | | | | |
| 18 | TFS | 0.2 | PETI-12 | 1.3 | 93 | 6 | PETI-10 | 0.85 | 52 | 25 | Comparative |
| | | | | | | | | | | | Example |
| 19 | TFS | 0.2 | PETI-5 | 1.0 | 27 | 6 | PETI-15 | 0.9 | 138 | 25 | Present |
| | | | | | | | | | | | Invention |
| 20 | TFS | 0.2 | PETI-10 | 1.0 | 53 | 25 | PETI-25 | 0.9 | 138 | 6 | Present |
| | | | | | | | | | | | Invention |
| 21 | TFS | 1.2 | PETI-10 | 1.0 | 53 | 25 | PETI-25 | 0.9 | 38 | 6 | Comparative |
| | | | | | | | | | | | Example |

The metal plate coated with polyester resin thus obtained was molded to a cylindrical can having a bottom by means of the wall-thinning deep drawing method described below.

The metal plate coated with polyester resin was punched out to a blank having diameter of 160 mm, followed by setting the surface coated with the white resin to be a outside of a can and then processing by the wall-thinning deep drawing to form a drawn can having bottom of 100 mm diameter. Then, the can was again subjected to the drawing molding to form a redrawn can having bottom of 80 mm diameter. The redrawn can was further subjected to a complex molding for simultaneously stretching and ironing to form a drawn ironed can having bottom of 65 mm diameter. This complex molding was carried out in the following conditions; the distance between the redrawn part, which was to be a top end of the can, and the ironed part was 20 mm, the radius at shoulder of a redrawing dice was 1.5 times of the plate thickness, the clearance between redrawing dice and punch was 1.0 times of the plate thickness, and the clearance at ironing molding part was 50% of the original plate thickness. Thereafter, the can top end was trimmed by a known art and applied with a neck-in processing and flange processing.

The evaluation methods for the polyester resin and the metal plate coated with polyester resin are explained below.

(Thickness of Rein Layer)

A non-oriented film was embedded in an epoxy embedding resin, followed by slicing in 5 μm thickness to measure by observing the sliced section with a microscope.

(Intrinsic Viscosity (IV Value))

The polyester resin was dissolved in a mixture of phenol/tetrachroroethane solution mixed in 1:1 ratio, followed by measurement of specific viscosity with a Ubellohde's viscometer in a constant temperature bath of 30° C. to obtain intrinsic viscosity value.

(Moldability)

The can molded by the wall-thinning deep drawing method was observed by eyes, followed by evaluation according to the following evaluation bases.

⊙: No fine crack and cut down the film was observed.

◯: Slight cracks which is not harmful for practical use was observed.

Δ: Cracks and cut down the film which are harmful for practical use were observed.

x: Shell should be broken in the molding processing.

(Corrosion Resistance)

The top end of the can molded with the wall-thinning deep drawing method was trimmed and then subjected to the neck-in processing and flange processing. The processed can was filled with water and sealed by fastening with a lid made of the same metal plate coated with polyester resin employed to the can, followed by pasteurization at 130° C. for 30 minutes, and then was held at 37° C. for 1 month. The can was opened after 1 month elapsed to observe occurrence of stain in the can by eyes, followed by evaluating moldability according to the following evaluation bases.

⊙: No stain was observed.

◯: Slight stain which is not harmful for practical use was observed.

Δ: Stain which is harmful for practical use was observed.

x: Significant amount of stain was observed on the surface.

(Preservation of Flavoring Properties)

The top end of the can molded with the wall-thinning deep drawing method was trimmed and then subjected to the neck-in processing and flange processing. The processed can was filled with coffee beverage and sealed by fastening with a lid made of the same metal plate coated with polyester resin employed to the can, followed by pasteurization in heated steam (130° C.) for 30 minutes, and then was held at 37° C. for 3 weeks. The can was opened after the weeks passed, and then fifty panelists investigated the change of flavor of content before and after the elapse of the time. The preservation of flavoring properties was evaluated based on the number of panelists who found no difference in flavor before and after the elapse of the time.

⊙: ≧40

◯: ≧35

Δ: <35, ≧30

x: <30

The evaluation results were exhibited in Table 2.

TABLE 2
Characteristic evaluation result

| | Result of Characteristics Evaluation | | | |
|---|---|---|---|---|
| Sample | | Corrosion | Flavoring | |
| No | Moldability | Resistance | Resistance | Classification |
| 1 | Δ | X | ◯ | Comparative Example |
| 2 | Δ | Δ | ◯ | Comparative Example |
| 3 | ◯ | ◯ | ◯ | Present Invention |
| 4 | ◯ | ◯ | ◯ | Present Invention |
| 5 | ⊚ | ⊚ | ◯ | Present Invention |
| 6 | ⊚ | ⊚ | ◯ | Present Invention |
| 7 | ⊚ | ◯ | ◯ | Present Invention |
| 8 | ⊚ | ⊚ | ◯ | Present Invention |
| 9 | Δ | X | ◯ | Comparative Example |
| 10 | ◯ | Δ | ◯ | Comparative Example |
| 11 | ⊚ | ◯ | ◯ | Present Invention |
| 12 | ⊚ | ◯ | ◯ | Present Invention |
| 13 | ⊚ | ◯ | ◯ | Present Invention |
| 14 | Δ | ◯ | ◯ | Comparative Example |
| 15 | ◯ | ◯ | ◯ | Present Invention |
| 16 | ⊚ | ⊚ | ⊚ | Present Invention |
| 17 | ⊚ | ⊚ | ⊚ | Present Invention |
| 18 | ◯ | Δ | ◯ | Comparative Example |
| 19 | ⊚ | ⊚ | ⊚ | Present Invention |
| 20 | ⊚ | ⊚ | ⊚ | Present Invention |
| 21 | X | no | no | Comparative Example |
| | | evaluation | evaluation | |

As shown in Table 2, any of the metal plates coated with polyester resin of the present invention are excellent in moldability and exhibit well corrosion resistance and preservation of flavoring properties; furthermore, the metal plate coated with two-layer resin includng a high crystalline polyester resin as the upper layer and a low crystalline polyester resin as the lower layer, is more excellent in corrosion resistance and preservation of flavoring properties.

### INDUSTRIAL APPLICABILITY

The present invention is a metal plate coated with polyester resin in which the metal plate is coated on at least one side thereof with a mono- or two-layer, wherein the monolayer is a polyester resin having an intrinsic viscosity of 0.6 to 1.4 and a half crystallization time of 50 seconds or more, or the two-layer is polyester resins including an upper layer polyester resin having a half crystallization time of less than 80 seconds and a lower layer polyester resin having a half crystallization time of 50 seconds or more wherein the intrinsic viscosities of both layers ranging from 0.6 to 1.4; and the metal plate of the invention does not generate cracks and fractures in the resin when being applied by a severe molding processing such as wall-thinning deep drawing, and exhibits excellent moldability and corrosion resistance. A can employing the metal plate coated with polyester resin of the invention is excellent in preservation of flavoring properties for content.

1. A metal plate, wherein the surface roughness Ra (JIS B 0601) is 1 μm or less, coated with polyester resin comprising a metal plate and a coating coated on at least one side of the metal plate with a polyester resin having an intrinsic viscosity of 0.6 to 1.4.

2. The metal plate coated with polyester resin according to claim 1, wherein the polyester resin has 50 seconds or more of a half crystallization time measured by a differential scanning calorimetry.

3. A metal plate according to claim 1 coated with a two-layer polyester resin coating coated on at least one side of the metal plate, wherein the two-layer coating comprises an upper layer of a polyester resin having less than 80 seconds of half crystallization time and a lower layer of a polyester resin having 50 seconds or more of half crystallization time.

4. The metal plate coated with polyester resin according to claim 3, wherein the half crystallization time of the upper layer is shorter than the half crystallization time of the lower layer.

5. The metal plate coated with polyester resin according to claim 1, wherein the polyester resin is non-oriented.

6. The metal plate coated with polyester resin according to claim 1, wherein the metal plate is any of a tinned steel plate, a tin-free steel plate or an aluminum alloy plate.

7. A can having a wall of the metal plate coated with polyester resin according to claim 1.

8. The metal plate coated with polyester resin according to claim 2, wherein the polyester resin is non-oriented.

9. The metal plate coated with polyester resin according to claim 3, wherein the polyester resin is non-oriented.

10. The metal plate coated with polyester resin according to claim 4, wherein the polyester resin is non-oriented.

11. The metal plate coated with polyester resin according to claim 4, wherein the metal plate is any of a tinned steel plate, a tin-free steel plate or an aluminum alloy plate.

12. The metal plate coated with polyester resin according to claim 5, wherein the metal plate is any of a tinned steel plate, a tin-free steel plate or an aluminum alloy plate.

13. A can having a wall of the metal plate coated with polyester resin according to claim 2.

14. A can having a wall of the metal plate coated with polyester resin according to claim 4.

15. A can having a wall of the metal plate coated with polyester resin according to claim 6.

16. A can having a wall of the metal plate coated with polyester resin according to claim 11.
